(19) United States
(12) Patent Application Publication
(10) Pub. No.: US 2008/0197608 A1
(43) Pub. Date: Aug. 21, 2008

(54) Powered utility cart with drivetrain differential

(76) Inventor: Gary J. Dixon, Mark, IL (US)

Correspondence Address: Gary J. Dixon, P.O. Box 122, Mark, IL, 61340, US

(21) Appl. No.: 12/150,366

(22) Filed: Apr. 28, 2008

Related U.S. Application Data
(63) Continuation-in-part of application No. 11/359,034, filed on Feb. 21, 2006.

(51) Int. Cl. B62B 1/04

(52) U.S. Cl. 280/654

(57) ABSTRACT

A hunting cart designed to assist a hunter with transporting objects such as hunting equipment and large game. The cart includes a pair of side rails that are arcuate in shape and parallel with each other. Interposed the side rails are a plurality of cross support members, a handle and an end rail defining the frame of the cart. A drive assembly is present that is operably connected to an axle, which is rotatably mounted to two wheels. The drive assembly includes an electric motor, a power source and a chain.

### CROSS REFERENCE TO RELATED APPLICATIONS

This is a continuation-in-part patent application to co-pending U.S. Non-provisional patent application having Ser. No. 11/359,034, filed Feb. 21, 2006, entitled “Motorized Hunting Cart, and having a common applicant herewith, which is incorporated herein in its entirety by reference.

### FIELD OF THE DISCLOSURE

The present invention relates to a hand-operated cart, more specifically but not by way of limitation, to a hand-operated cart that utilizes a motor or engine to operably engaged wheels to assist an operator to carry heavy loads such as, but not limited to, large hunted game, over a variety of terrains.

### BACKGROUND

Hunting large game such as deer is a sport that is enjoyed by thousands of individuals. Typically when engaged in the sport of hunting, a hunter will traverse through a desired area such as a forest. It is common for hunters to walk many miles to a particular hunting destination. Conversely, some hunters choose to travel periodically throughout the day. Hunters typically carry gear such as food rations and other hunting supplies during their hunting trip. The terrain that hunters must enter is usually rough with a variety of hills and slopes. Navigating this type of terrain while carrying heavy loads can present several obstacles and hazards to the hunter.

Carrying heavy loads while traversing treacherous terrain can be present a significant potential health hazard to the hunter. As the treacherous terrain does not provide a solid horizontal support structure for walking, the hunter is at risk for potential back, leg or ankle injury. Furthermore, while traversing long distances across such terrain the hunter's muscles can become fatigued, this can increase the chance for injury.

Another issue occurs when the hunter has been successful and has killed a large game animal such as a deer. Typically the hunter is a significant distance away from his vehicle. Transporting the deer and the hunting equipment presents a significant challenge for a single individual. Conventional carts have provided some assistance with this task, however pulling a manual cart that is loaded with hunting equipment and/or wild game across the difficult terrain has proven to be undesirable, if not unachievable, for many hunters.

Accordingly, there is a need for a hand-controlled (i.e., hand-operated) cart that facilitates the transportation of heavy loads such as, but not limited to, hunting equipment and large wild game across a variety of terrains and that provides motorized assistance for moving the cart.

### SUMMARY OF THE DISCLOSURE

It is the object of the present invention to provide a hand-operated cart designed to assist hunters transport heavy loads such as hunting equipment and large wild game over a variety of terrains.

It is a further object of the present invention to provide a hand-operated cart that provides a method of motorized movement to assist the hunter in moving the cart across a variety of terrains.

It is a further object of the present invention to provide such motorized movement via a motor, engine or other suitable type of power generation apparatus.

It is a further object of the present invention for such motorized movement to include wheel differentiating functionality for allowing the hand-operated kart to be easily and readily steered.

It is another object of the present invention to provide a hand-operated cart with motorized movement assistance that is collapsible so as to facilitate storage in small areas.

Yet another object of the present invention is to provide a hand-operated cart that provides a method of motorized movement that has wheels that are resistant to puncture damage.

It is a further object of the present invention to provide a hand-operated cart with motorized movement assistance that has an integrated brake system.

In one embodiment of the present invention, a walk-behind hand-controlled utility cart comprises a frame assembly, an axle assembly and a drive assembly. The frame assembly includes a lower frame structure and an upper frame structure. A first end portion of the lower frame structure is attached to a first end portion of the upper frame structure in a manner allowing the frame structures to be selectively situated in use and storage orientations with respect to each other. The upper frame structure extends upwardly with respect to a top surface of the lower frame structure when the frame structures are in the use orientation. The axle assembly is rotatably attached to the lower frame structure and is positioned below a bottom surface of the lower frame structure. The axle assembly includes spaced apart axially aligned axle shafts and a differential unit coupled between the axle shafts for allowing rotational power applied to the differential unit to be differentially applied between the axle shafts. The drive assembly is fixedly attached to the lower frame assembly. A rotational power output portion of the drive assembly is coupled to the axle assembly in a manner allowing rotational power generated by the drive assembly to be delivered to the differential unit.

In another embodiment of the present invention, a walk-behind hand-controlled utility cart comprises a frame assembly, an axle assembly, two wheel units, a drive assembly, a chain and a control device. The frame assembly includes a lower frame structure, an upper frame structure and a frame structure retention member. A first end portion of the lower frame structure is pivotably attached to a first end portion of the upper frame structure for allowing the frame structures to be selectively moved between use and storage orientations with respect to each other. The frame structure retention member is detachably connected between the frame structures for securing the frame structures in the use orientation. The upper frame structure extends upwardly with respect to a top surface of the lower frame structure when the frame structures are in the use orientation. The axle assembly is rotatably attached to the lower frame structure and is positioned below a bottom surface of the lower frame structure. The axle assembly includes two axially aligned axle shafts each having opposing end portions and a differential unit coupled between a first end portion of each one of the axle shafts for allowing rotational power applied to the differential unit to be differentially applied between the axle shafts. A second end portion of each one of the axle shafts has a respective one of the wheel units fixedly attached thereto in a manner precluding relative rotation of the wheel unit with respect to the attached one of the axle shafts. The drive assembly is fixedly mounted on the lower frame structure below the bottom surface thereof. The drive assembly includes an electric motor that generates rotational power. The chain is coupled between the electric motor of the drive assembly and the differential unit for allowing the rotational power generated by the electric motor to be delivered to the differential unit. The control device is coupled to the drive assembly for allowing selective output of the rotational power from the electric motor and is attached to a second end portion of the upper frame structure.

In another embodiment of the present invention, a kit for constructing a walk-behind hand-controlled utility cart comprises a lower frame structure, an upper frame structure, an axle assembly and a drive assembly. The lower frame structure has opposing end portions, axle assembly mounts and drive assembly mounts. A first one of the end portions of the lower frame structure includes spaced apart interconnect members. The upper frame structure has opposing end portions and opposing major surfaces. A first one of the end portions of the supper frame structure includes spaced apart interconnect embers. Each one of the upper frame structure interconnect members are configured for being connected to a respective one of the upper frame structure interconnect members for allowing the frame structures to be selectively moved between use and storage orientations with respect to each other. The axle assembly is rotatably attachable to the axle assembly mounts of the lower frame structure. The axle assembly includes spaced apart axially aligned axle shafts and a differential unit coupled between the axle shafts for allowing rotational power applied to the differential unit to be differentially applied between the axle shafts. The drive assembly is attachable to the drive assembly mounts of the lower frame structure. A rotational power output portion of the drive assembly can be coupled to the axle assembly in a manner allowing rotational power generated by the drive assembly to be delivered to the differential unit.

These and other objects, embodiments, advantages and/or distinctions of the present invention will become readily apparent upon further review of the following specification, associated drawings and appended claims.

### BRIEF DESCRIPTION OF THE DRAWINGS

The present disclosure is further made in the detailed description that follows, by reference to the noted drawings, by way of non-limiting examples of embodiments in which like reference numerals represent similar parts throughout several views of the drawings, and in which:

FIG. 1 is a perspective view of a non-folding hand-operated cart in accordance with an embodiment of the present invention;

FIG. 2 is a perspective view of a folding hand-operated cart having a drivetrain differential configured in accordance with an embodiment of the present invention;

FIG. 3 is a perspective view revealing visually obstructed components of the cart in FIG. 2;

FIG. 4 is a cross-sectional view taken along the line 4-4 in FIG. 3, which shows the cart in use configuration;

FIG. 5 is a cross-sectional view of the cart in FIG. 4, which shows the cart in a folded configuration; and

FIG. 6 is a fragmentary top view revealing visually obstructed components of upper frame structure of the cart shown in FIG. 2.

### DETAILED DESCRIPTION

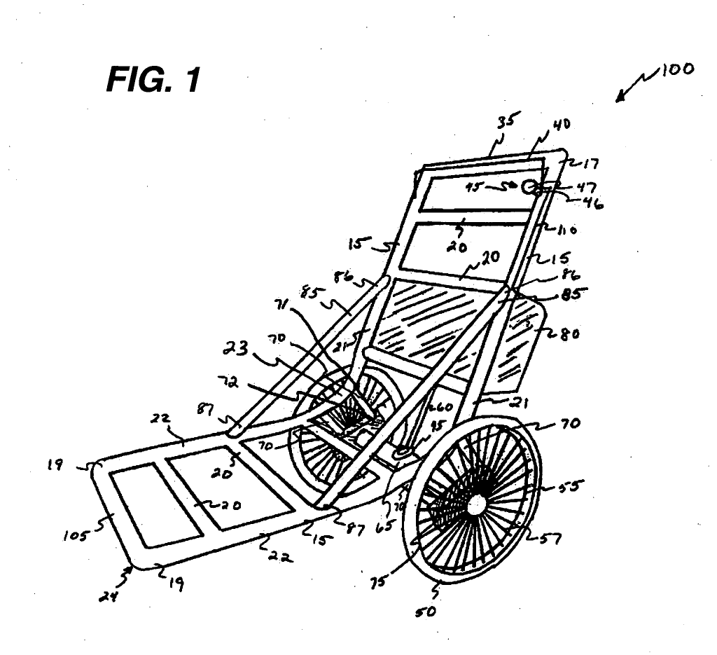

Referring to the embodiment in FIG. 1 wherein like elements are designated with identical reference numerals throughout the figure and wherein various elements depicted therein are not necessarily drawn to scale, and in particular in FIG. 1 there is illustrated a hand cart 100 that is constructed according the principles of the present invention.

The hand cart 100 comprises two outer side rails 15 that are generally tubular in shape. The outer side rails 15 are parallel with respect to each other and define the peripheral edge of the hand cart 100. The outer side rails 15 are manufactured from a durable rigid and lightweight material. More specifically but not by way of limitation the outer side rails 15 are manufactured from aluminum tubing. The outer side rails 15 are manufactured by conventional methods such as bending in such a manner whereby the outer side rails 15 are arcuate in shape creating an upper section 21 and a lower section 22 for each outer side rail 15. The outer side rails 15 are bent in whereby the lower section 22 and the upper section 21 extend in an upward direction with respect to the midpoint 23 of the outer side rails 15.

Interposed to the outer side rails 15 and generally perpendicular thereto is a plurality of cross support members 20. The cross support members 20 are tubular in shape and function to connect the outer side rails 15 and combine therewith to define the frame 24 of the hand cart 100. The cross support members 20 are manufactured from a durable rigid material such as but not limited to aluminum. The cross support members 20 are mechanically fastened to the outer side rails 15 by conventional methods such as but not limited to welding. While no specific numbers of cross support members 20 are required good results have been achieved with six cross support members.

Intermediate the first ends 17 of the upper section 21 of the outer side rail 15 is a handle 35. The handle 35 is fastened to the first ends of the outer side rail 15 by conventional methods such as welding. The handle 35 is tubular in shape and is manufactured from a suitable durable and rigid material such as aluminum. Although the handle 35 is shown as being a tubular shaped piece of material in the drawing submitted herewith, it is contemplated within the scope of the present invention that the handle 35 could be coated with a material that would facilitate a method of gripping. More specifically but not by way of limitation the handle could be coated with a rubber surface to produce a more secure method of gripping the hand cart 100 while traversing across a given terrain.

Distally located from the handle 35 proximate to the second ends 19 of the outer side rails 15 and interposed thereto is an end rail 105. The end rail 105 is secured to the second ends 19 of the side outer rails 15 by conventional methods such as but not limited to welding. The end rail 105 in combination with the lower section 22 of the outer side rails 15 serves to define the lower platform area 97 of the hand cart 100. The end rail 105 also functions to support the hand cart in its first position whereby the end rail 105 is adjacent to a suitable horizontal support structure such as the ground. In this position a hunter can load objects onto the lower platform area 97.

Mechanically fastened by conventional methods such as welding to the outer side rails 15 is a pair of side brace members 85. The side brace members 85 are constructed from a suitable rigid material such as but not limited to aluminum tube. The side brace members 85 have a first end 86, which is fastened to the upper section 21 of the outer side rail 15. The second end 87 is mechanically fastened to the lower section 22 of the same outer side rail 15. While no specific attachment point is necessary, the first end 86 and second end 87 should be attached along the outer side rail on opposite sides of the midpoint 23. This positioning allows the side brace members 85 to provide the structural support necessary for the outer side rails 15 when the hand cart 100 is engaged with heavy loads. Although the side brace members 85 and outer side rails 15 are illustrated in the drawings submitted herewith and being a solid tubular structure, it is contemplated within the scope of the present invention that proximate to the first end 86 and the second end 87 of the side brace members 85 a conventional hinge would be located thereby facilitating the folding of the upper section 21 and the lower section 22 of the outer side rails 15 towards and be generally adjacent to the side brace members 85 for ease of storage.

Integrally connected with the outer side rails 15 and extending downward therefrom are four axle support members 70. Two axle support members 70 are fastened to each outer side rails 15. Each axle support member 70 is proximate to the midpoint 26 and located adjacently opposite thereto. The axle support members 70 have a first end 71 that is fastened to the outer side rails 15 by conventional methods such as welding. Each pair of axle support members 70 along the outer side rails 15 are mounted on opposite sides of the midpoint 26 whereby one axle support member 70 is proximate to the upper section 21 and the opposite axle support member 70 is mounted on the same outer side rail 15 is proximate to the lower section 22 of the outer side rail 15. This allows the hand cart 100 to be easily managed and balanced on the wheels 55 when in use across different terrains with a heavy load.

Surroundably mounted to the axle support members 70 are a two axle connection members 75. The axle connection members 75 are generally square in shape and are fastened by conventional methods to the second ends 72 of the axle support member 70 distal to the outer side rail 15. The axle connection members 75 are configured to receive therein axle 65. The axle 65 is a conventional metal rod having two ends. The axle 65 is rotatably interposed the axle connection members 75. The ends of the axle 65 extending outward therefrom are mechanically fastened by conventional methods to a wheel 55. The wheel 55 is a conventional wheel that utilizes a plurality of spokes 57 for structural support. The wheel 55 further includes an inflatable tire 50 that functions to provide traction across different types of terrains. It is further contemplated within the scope of the present invention that the tire 50 is made from a material that is resistant to punctures or is equipped with a self-sealing air tube in the event that an object protrudes through the tire 50.

Intermediate along the axle 65 is a sprocket 95. The sprocket 95 is mechanically fastened to the axle by conventional methods such as but not limited to bolts. The sprocket 95 is a standard sprocket that is annular in shape and has a plurality of teeth disposed along a peripheral edge that is configured to receive thereon one end of a chain 60. The chain 60 serves to operably connect the drive assembly 80 with the axle 65. Those skilled in the art should recognize that numerous different devices could be used in place of and/or in conjunction with the chain 60. More specifically but not by way of limitation, a belt or shaft could be used to operably interconnect the drive assembly 80 with the axle 65. The drive assembly 80 is positioned intermediate the outer side rails 15 proximate to the upper section 21 of the hand cart 100. The drive assembly 80 is secured by conventional methods to the outer side rails 15 opposite the first end 86 of the side brace members 85. The drive assembly 80 is a generally rectangular box constructed of suitable weatherproof material such as but not limited to aluminum. The drive assembly 80 has contained therein a conventional DC electric motor and a renewable power source such as a DC battery. Those skilled in the art will recognize that numerous different types of motors could be utilized in place of and/or in conjunction with the electric motor referenced herein. More specifically but not by way of limitation, the drive assembly 80 could have disposed therein a conventional gas engine and fuel supply tank. The drive assembly 80 further contains a sprocket that is configured to receive one end of the chain 60. The drive assembly 80 being operably connected to the axle 65 via the chain 60 functions to provide the user of the hand cart 100 a method of providing power assistance to drive the wheels 55.

The drive assembly 80 is controlled with a lever 40 that is pivotally mounted adjacent to the handle 35 to the outer side rails 15. The lever 40 consists of a first end and a second end with each end being pivotally secured to an outer side rail 15 proximate to the first end 17. The lever 40 is a conventional mechanical lever that is connected to the drive assembly 80 via a cable 110. The cable 110 is secured internally by mechanical methods along the outer side rail 15. The lever 40 has a first position in which the motor disposed within the drive assembly 80 is disengaged with the chain 60 thereby eliminating the transfer of power from the drive assembly 80 to the axle 65. In its second position the lever 40 is biased against the handle 35 by a user's hand. In its second position the lever 40 biases the cable 110 which functions to engage the drive assembly 80 with the chain 60. As the chain 60 is operably engaged to the axle 65, this provides motorized assistance in moving the hand cart 100 across the desired terrain.

Integrally mounted to one of the outer side rails 15 is a throttle 45. The throttle 45 functions to control the speed of the hand cart 100 once the lever 40 is engaged in its second position. The throttle 45 is manufactured with a rod 46 and a knob 47 secured thereto. The throttle shift 45 is manufactured from suitable durable materials such as but not limited to plastic.

Although the hand cart 100 is illustrated with only a lever 40 pivotally mounted to the handle 35, it is contemplated within the scope of the present invention that the hand cart 100 could have integrated thereon a standard mechanical caliper brake system to provide assistance to the user in slowing the forward or backward movement of the hand cart 100 when traversing across sloped terrain. It is further contemplated within the scope of the invention that the frame 24 be coated with a durable coating material in a plurality of colors such as but not limited to powder coating to provide protection for the frame 24. Those skilled in the art should recognize that the frame 24 could be constructed from numerous different materials in a variety of shapes and sizes in place of and/or in conjunction with the materials suggested herein. Furthermore, those skilled in the art should also recognize that the frame 24 could be manufactured with different wall thicknesses in order to manufacture different models having distinct load capabilities. It should further be recognized that the hand cart 100 described herein could be utilized for numerous applications in addition to the aid in transportation of hunting equipment and large wild game. More specifically but not by way of limitation the hand cart 100 could be utilized to transport groceries or picnic equipment.

Referring in particular to the drawing submitted herewith, a description of the operation of the hand cart 100 is as follows. A user will place the desired material to be transported such as hunting equipment or large wild game on the lower platform area 97 of the hand cart 100 while the hand cart 100 is in its first position whereby the end rail 105 is adjacent to a suitable horizontal support structure such as the ground. The user then applies the necessary force to the handle 35 in a downward direction to place the hand cart 100 in its second position whereby the hand cart 100 is centrally balanced over the wheels 55. The user then pulls the cart in a desired direction to begin the transportation process. During the transportation process the user can engage the lever 40 in its second position thereby activating the chain 60 that operably connects the drive assembly 80 to the axle 65. The user can further control the speed of the hand cart 100 by utilizing the throttle 45.

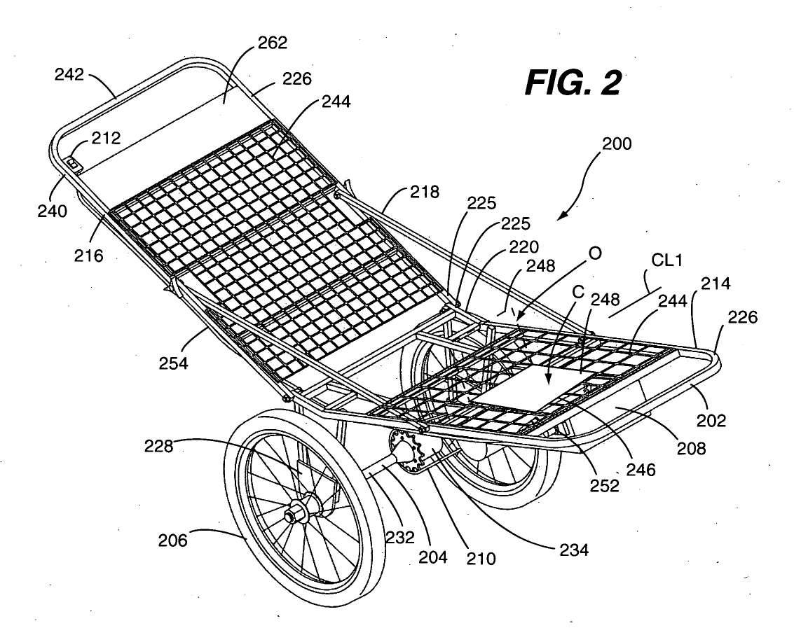

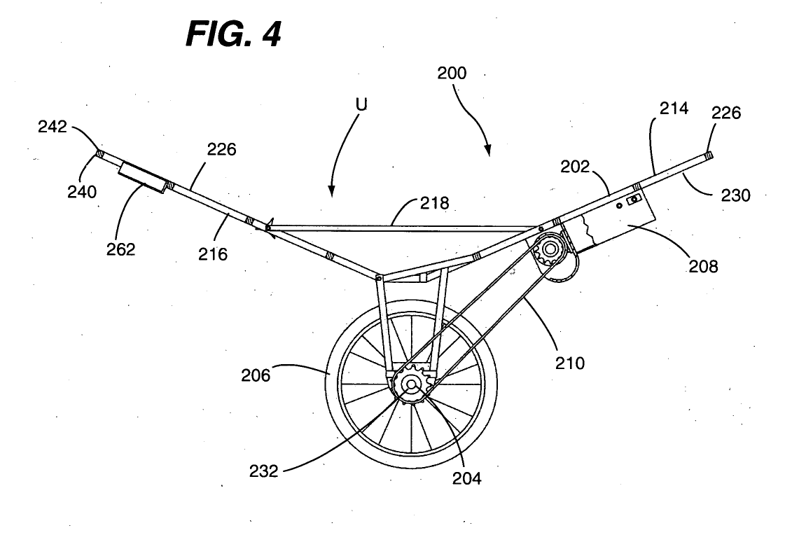

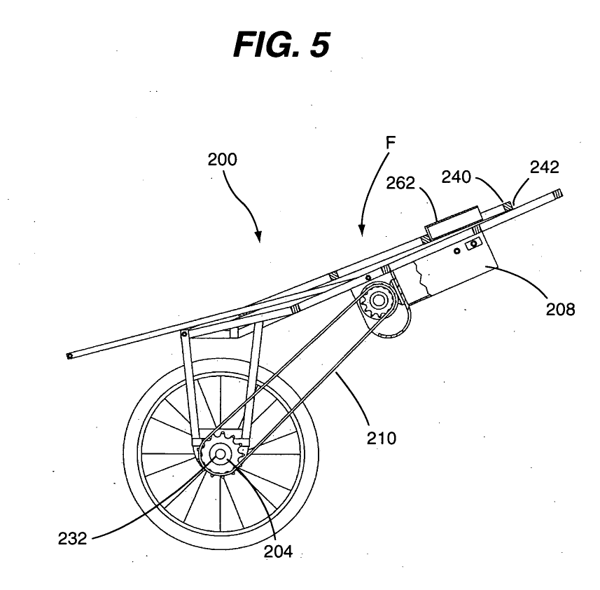

Referring now to FIGS. 2-6, a foldable hand-operated cart 200 in accordance with an embodiment of the present invention is shown. The cart 200 includes a frame assembly 202, an axle assembly 204, wheel units 206, a drive assembly 208, a chain 210, and a control device 212. The frame assembly 202 includes a lower frame structure 214, an upper frame structure 216 and frame structure retention members 218, which can be made from any suitable metal, plastic or composite material. A first end portion 220 of the lower frame structure 214 is pivotably attached to a first end portion 222 of the upper frame structure 224 for allowing the frame structures 214, 216 to be selectively moved between a use orientation U (FIGS. 2-4) and a folded orientation F (FIG. 5) with respect to each other. One or both ends of the frame structure retention members 218 are detachably connected between the frame structures 214, 216 for securing the frame structures 214, 216 in the use orientation U. The upper frame structure 216 extends upwardly with respect to a top surface 226 of the lower frame structure 214 when the frame structures 214, 216 are in the use orientation U. It is disclosed herein that the frame structure retention members 218 can be provided in any form and are not limited to being elongated members. For example, a retention arrangement can be integral with or in combination with hinge members 225 of the frame structures 214, 216, which provide for pivoting of the frame structures 214, 216 with respect to each other.

It is contemplated herein that other interconnect arrangements for the frame structures 214, 216 are possible such as, for example, interconnect arrangements that allow the frame structures 214, 216 to be detached from each other rather than pivoted. Thus, it is disclosed herein that an embodiment of the present invention can be configured in the same manner as the cart 200, but with the frame structures 214, 216 being detachable rather than being pivotably foldable.

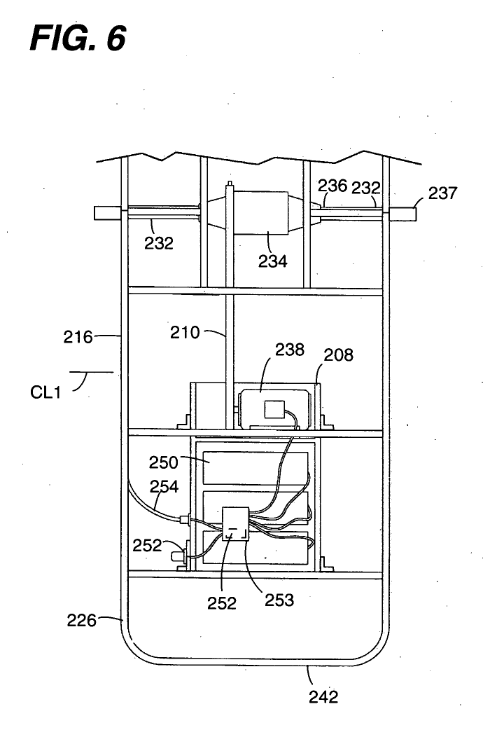

Referring now to FIGS. 2-6, the axle assembly 204 is rotatably attached to the lower frame structure 214 through axle mounts 228. The axle mounts 228 are attached to the lower frame structure 214 in a manner whereby the axle assembly 204 is positioned below a bottom surface 230 of the lower frame structure 216. As best shown in FIG. 6, the axle assembly 204 includes two axially aligned axle shafts 232 each having opposing end portions and a differential unit 234. The differential unit 234 is coupled between a first end portion 236 of each one of the axle shafts 232 for allowing rotational power applied to the differential unit 234 via the chain 210 (or optionally a belt, not shown) to be differentially applied between the axle shafts 232. A second end portion 237 of each one of the axle shafts 232 has a respective one of the wheel units 206 fixedly attached thereto in a manner precluding relative rotation of the wheel unit 206 with respect to the attached one of the axle shafts 232. Each wheel unit 206 includes a rim and a tire mounted on/attached to the rim. Embodiments of the present invention are not limited to a particular type of tire or rim. For example, the rims can be spokes or solid and the tires can be pneumatic, solid or hollow.

Advantageously, the differential unit 234 allows for ease of maneuverability of the cart 200. More specifically, the differential unit 234 allows the two wheel units, which are fixedly attached to the axle shafts 232, to rotate at different speeds. Thus, when steering the cart 200, the differential unit 234 allows the two axle shafts 232 to rotate at different speeds while rotational power being applied to differential unit 234 is still being transmitted to at least one of the axle shafts 232. Without such a differential unit, turning the cart would require skidding or skipping of the cart, or would require rotational power being applied to only one wheel unit (i.e., one wheel unit 206 freewheeling).

It is disclosed herein that the differential unit 234 can be of any number of operating configurations. Examples of such operating configurations include a speed sensing differential configuration, a torque sensing differential configuration, and the like. One specific example of a suitable differential is that offered by Peerless Company, which has model no. 141D. The differential unit 234 effectively allows one of the axle shafts 232 to rotationally slip with respect to the other one of the axle shafts 232. Put differently, the differential unit 234 allows the wheel units 206 to travel through a turn at different rotational speeds thereby allowing the cart 200 to smoothly negotiate the turn as opposed to binding and/or hopping as the cart goes around the turn.

The drive assembly 208 is fixedly mounted on the lower frame structure 214 below the bottom surface 230 thereof. The drive assembly 204 includes an electric motor 238 that generates rotational power. Embodiments of the present invention are not limited to a particular type, size and/or configuration of motor. The chain 210 is coupled between the electric motor 238 of the drive assembly 208 and the differential unit 234 such as via respective sprockets. Through such chained interconnection, rotational power generated by the electric motor 238 can be delivered to the differential unit 234 and, thereby, to the wheel units 206.

As best shown in FIG. 2, a layer of support material 244 is mounted on each one of the frame structure 214, 216 over the respective top surface 226. A steel mesh material is one example of such a layer of support material. Other examples of the layer of support material 244 include, but are not limited to, a sheet of wood, a sheet of plastic, plastic mesh material, and the like. An access opening 246 is provided within the layer of support material 244 over at least a portion of the drive assembly 208. An access opening cover 248 is attached (e.g., hingedly and/or removably) to the layer of support material 244 in a manner allowing the access opening cover 248 to be selective moved between a position that covers the access opening 246 (i.e., open position O) and a position that allows access to the drive assembly 208 through the access opening 246 (i.e., closed position C).

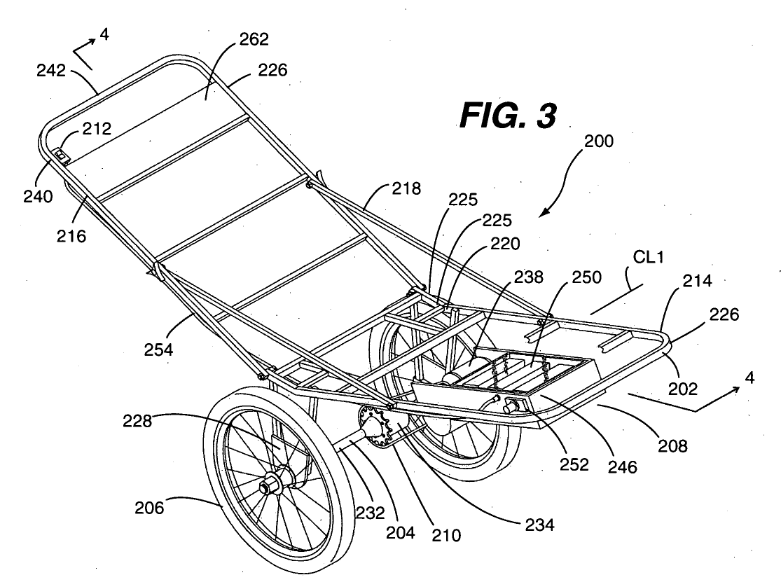

The control device 212 (FIGS. 2 and 3) is coupled to the drive assembly 208 for allowing selective output of the rotational power from the electric motor 238. The control device 212 is attached to a second end portion 240 of the upper frame structure 216. It is disclosed herein that the control device 212 can take on any number of forms. As depicted, an on/off switch is one example of the control device 212. Alternatively, a squeeze bar type pf apparatus can be mounted on or adjacent to a hand-gripping portion 242 of the upper frame structure 216 thereby allowing selective output of the rotational power from the electric motor 238 only when the squeeze bar type is depressed (i.e., displaced from a static position). Referring to FIG. 3, the drive assembly 208 includes one or more batteries 250 electrically connected to the motor 238 through a wire or cable (not specifically shown) and recharging circuitry 252 electrically connected to the at least one battery through a wire or cable (not specifically shown). The control device 212 is electrically connected to the drive assembly 208 through a wire or cable 254. It is disclosed herein that the recharging circuitry 252 can be part of a controller 253 through which all electrical power of drive assembly 208 is managed and/or controlled.

In one embodiment of the present invention, as shown in FIG. 206, the axle assembly 204 is generally located between a transverse centerline CL1 of the lower frame structure 214 and the first end portion 226 of the lower frame structure 214, and the drive assembly 208 is generally located between the transverse centerline CL1 of the lower frame structure 214 and a second end portion 256 of the lower frame structure 214. In this manner, the drive assembly 208 serves to at least partially counterbalance cargo supported by the upper frame structure 216. It is disclosed herein that one or more batteries 250 of the drive assembly 208 or a remotely located battery (i.e., battery 258) can be mounted on the upper frame structure 216, as shown in FIG. 2, and be coupled to the motor 238 via the cable 258, thus serving to at least partially counterbalance components of the drive assembly 208 that are mounted on the lower frame structure 214.

As shown in FIGS. 2-5, a tool tray 262 is attached to the upper frame structure 216 adjacent the control device 212 and/or hand gripping portion 242. The tool tray 262 can be configured with a single compartment (shown) or with a plurality of compartments. The tool tray 262 allows items such as a flashlight, knife, handgun, tools and the like to be stored in a manner whereby they are readily accessible by an operator of the cart 200.

From the foregoing discussion, it will be appreciated that a kit for constructing a walk-behind hand-controlled utility cart in accordance with the present invention can be provided. In one embodiment, such a kit can be configured for constructing the cart 200. In such an embodiment, the kit includes a lower frame structure, an upper frame structure, an axle assembly and a drive assembly. The lower frame structure has opposing end portions, axle assembly mounts and drive assembly mounts. A first one of the end portions of the lower frame structure includes spaced apart interconnect members. The upper frame structure has opposing end portions and opposing major surfaces. A first one of the end portions of the supper frame structure includes spaced apart hinge members. Each one of the upper frame structure interconnect members are configured for being connected to a respective one of the upper frame structure interconnect members for allowing the frame structures to be selectively moved between use and storage orientations with respect to each other. The axle assembly is rotatably attachable to the axle assembly mounts of the lower frame structure. The axle assembly includes spaced apart axially aligned axle shafts and a differential unit coupled between the axle shafts for allowing rotational power applied to the differential unit to be differentially applied between the axle shafts. The drive assembly is attachable to the drive assembly mounts of the lower frame structure. A rotational power output portion of the drive assembly can be coupled to the axle assembly in a manner allowing rotational power generated by the drive assembly to be delivered to the differential unit.

The drive assemblies depicted herein each include a motor for producing rotational power. As such, a rotational power output portion of a drive assembly in accordance with the present invention can be that of a motor. Alternatively, a rotational power output portion of a drive assembly in accordance with the present invention can be that of an internal combustion engine that generates rotational power (i.e., torque delivered via a rotating shaft). Associated components to a motor are analogous to such an engine (e.g., a gas tank in place of batteries and a throttle control in place of a switch).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A walk-behind hand-controlled utility cart, comprising:
a frame assembly including a lower frame structure and an upper frame structure, wherein a first end portion of the lower frame structure is pivotably attached to a first end portion of the upper frame structure for allowing said frame structures to be selectively moved between use and storage orientations with respect to each other and wherein the upper frame structure extends upwardly with respect to a top surface of the lower frame structure when said frame structures are in said use orientation;
an axle assembly rotatably attached to the lower frame structure, wherein the axle assembly is positioned below a bottom surface of the lower frame structure and wherein the axle assembly includes spaced apart axially aligned axle shafts and a differential unit coupled between said axle shafts for allowing rotational power applied to the differential unit to be differentially applied between said axle shafts; and
a drive assembly fixedly attached to the lower frame assembly, wherein a rotational power output portion of the drive assembly is coupled to the axle assembly in a manner allowing rotational power generated by the drive assembly to be delivered to the differential unit.

2. The utility cart of claim 1 wherein:
a layer of support material is mounted on the lower frame structure over the top surface;
an access opening over at least a portion of the drive assembly is provided within the layer of support material; and
an access opening cover is attached to the layer of support material over the access opening in a manner allowing the access opening cover to be selective moved between a position that covers the access opening and a position that allows access to the drive assembly through the access opening.

3. The utility cart of claim 1 wherein:
the axle assembly is generally located between a transverse centerline of the lower frame structure and the first end portion of the lower frame structure; and
the drive assembly is generally located between a transverse centerline of the lower frame structure and a second end portion of the lower frame structure such that the drive assembly serves to counterbalance cargo supported by the upper frame structure.

4. The utility cart of claim 1, further comprising:
a chain, wherein the rotational power output portion of the drive assembly includes a first sprocket, the differential unit includes a second sprocket, and the chain is engaged around said sprockets.

5. The utility cart of claim 1 wherein:
the rotational power output portion of the drive assembly includes an electric motor; and
the drive assembly includes at least one battery connected to the electric motor and recharging circuitry connected to said at least one battery.

6. The utility cart of claim 5, further comprising:
a chain, wherein the motor includes a first sprocket, the differential unit includes a second sprocket, and the chain is engaged around said sprockets.

7. The utility cart of claim 6 wherein:
the axle assembly is generally located between a transverse centerline of the lower frame structure and the first end portion of the lower frame structure;
the rotational power output portion of the drive assembly is generally located between a transverse centerline of the lower frame structure and a second end portion of the lower frame structure such that the drive assembly serves to counterbalance cargo supported by the upper frame structure; and
said at least one battery is mounted on the upper frame structure.

8. The utility cart of claim 1 wherein:
a layer of support material is mounted on the lower frame structure over the top surface;
an access opening over at least a portion of the drive assembly is provided within the layer of support material; and
an access opening cover is attached to the layer of support material over the access opening in a manner allowing the access opening cover to be selective moved between a position that covers the access opening and a position that allows access to the drive assembly through the access opening.

9. A walk-behind hand-controlled utility cart, comprising:
a frame assembly including a lower frame structure, an upper frame structure and a frame structure retention member, wherein a first end portion of the lower frame structure is pivotably attached to a first end portion of the upper frame structure for allowing said frame structures to be selectively moved between use and storage orientations with respect to each other, wherein the frame structure retention member is detachably connected between said frame structures for securing said frame structures in said use orientation, and wherein the upper frame structure extends upwardly with respect to a top surface of the lower frame structure when said frame structures are in said use orientation;
an axle assembly rotatably attached to the lower frame structure, wherein the axle assembly is positioned below a bottom surface of the lower frame structure and wherein the axle assembly includes two axially aligned axle shafts each having opposing end portions and a differential unit coupled between a first end portion of each one of said axle shafts for allowing rotational power applied to the differential unit to be differentially applied between said axle shafts;
two wheel units, wherein a second end portion of each one of said axle shafts has a respective one of said wheel units fixedly attached thereto in a manner precluding relative rotation of said wheel unit with respect to the attached one of said axle shafts;
a drive assembly fixedly mounted on the lower frame structure below the bottom surface thereof, wherein the drive assembly includes an electric motor that generates rotational power;
a chain coupled between the electric motor of the drive assembly and the differential unit for allowing said rotational power generated by the electric motor to be delivered to the differential unit; and
a control device coupled to the drive assembly for allowing selective output of said rotational power from the electric motor, wherein the control device is attached to a second end portion of the upper frame structure.

10. The utility cart of claim 9 wherein:
a layer of support material is mounted on the lower frame structure over the top surface;
an access opening over at least a portion of the drive assembly is provided within the layer of support material; and
an access opening cover is attached to the layer of support material over the access opening in a manner allowing the access opening cover to be selective moved between a position that covers the access opening and a position that allows access to the drive assembly through the access opening.

11. The utility cart of claim 9 wherein:
the axle assembly is generally located between a transverse centerline of the lower frame structure and the first end portion of the lower frame structure; and
the drive assembly is generally located between a transverse centerline of the lower frame structure and a second end portion of the lower frame structure such that the drive assembly serves to counterbalance cargo supported by the upper frame structure.

12. The utility cart of claim 9 wherein the drive assembly includes at least one battery connected to the motor and recharging circuitry connected to said at least one battery.

13. The utility cart of claim 12 wherein:
the axle assembly is generally located between a transverse centerline of the lower frame structure and the first end portion of the lower frame structure;
the rotational power output portion of the drive assembly is generally located between a transverse centerline of the lower frame structure and a second end portion of the lower frame structure such that the drive assembly serves to counterbalance cargo supported by the upper frame structure; and
said at least one battery is mounted on the upper frame structure.

14. The utility cart of claim 13 wherein:
a layer of support material is mounted on the lower frame structure over the top surface;
an access opening over at least a portion of the drive assembly is provided within the layer of support material; and
an access opening cover is attached to the layer of support material over the access opening in a manner allowing the access opening cover to be selective moved between a position that covers the access opening and a position that allows access to the drive assembly through the access opening.

15. A kit for constructing a walk-behind hand-controlled utility cart, comprising:
a lower frame structure having opposing end portions, axle assembly mounts and drive assembly mounts, wherein a first one of said end portions including spaced apart hinge members;
an upper frame structure having opposing end portions and opposing major surfaces, wherein a first one of said end portions including spaced apart hinge members, wherein each one of said upper frame structure hinge members are configured for being connected to a respective one of said upper frame structure hinge members for allowing said frame structures to be selectively moved between use and storage orientations with respect to each other;
an axle assembly rotatably attachable to said axle assembly mounts of the lower frame structure, wherein the axle assembly includes spaced apart axially aligned axle shafts and a differential unit coupled between said axle shafts for allowing rotational power applied to the differential unit to be differentially applied between said axle shafts; and
a drive assembly attachable to said drive assembly mounts of the lower frame structure, wherein a rotational power output portion of the drive assembly can be coupled to the axle assembly in a manner allowing rotational power generated by the drive assembly to be delivered to the differential unit.

16. The kit of claim 15 wherein:
a layer of support material is provided for being mounted on the lower frame structure over the top surface;
an access opening over is provided within the layer of support material at a position over at least a portion of the drive assembly when the layer of support material mounted on the lower frame structure; and
an access opening cover is attached to the layer of support material over the access opening in a manner allowing the access opening cover to be selective moved between a position that covers the access opening and a position that allows access to the drive assembly through the access opening.

17. The kit of claim 15 wherein:
said axle assembly mounts are positioned such that the axle assembly is mountable between a transverse centerline of the lower frame structure and the first end portion of the lower frame structure; and
said drive assembly mounts are positioned such that the rotational power output portion of the drive assembly is mountable between a transverse centerline of the lower frame structure and a second end portion of the lower frame structure such that the drive assembly serves to counterbalance cargo supported by the upper frame structure.

18. The kit of claim 15 wherein:
the rotational power output portion of the drive assembly includes an electric motor; and
the drive assembly includes at least one battery connected to the electric motor and recharging circuitry connected to said at least one battery;
the upper frame structure includes battery mounts for allowing said at least one battery to be mounted on the upper frame structure.

19. The kit of claim 18 wherein:
said axle assembly mounts are positioned such that the axle assembly is mountable between a transverse centerline of the lower frame structure and the first end portion of the lower frame structure; and
said drive assembly mounts are positioned such that at least the rotational power output portion of the drive assembly is mountable between a transverse centerline of the lower frame structure and a second end portion of the lower frame structure such that the drive assembly serves to counterbalance cargo supported by the upper frame structure.

20. The kit of claim 19 wherein:
a layer of support material is provided for being mounted on the lower frame structure over the top surface;
an access opening over is provided within the layer of support material at a position over at least a portion of the drive assembly when the layer of support material mounted on the lower frame structure; and
an access opening cover is attached to the layer of support material over the access opening in a manner allowing the access opening cover to be selective moved between a position that covers the access opening and a position that allows access to the drive assembly through the access opening.
